(19) United States
(12) Patent Application Publication
(10) Pub. No.: US 2007/0032889 A1
(43) Pub. Date: Feb. 8, 2007

(54) A Method and a computer system to calculate material requirements for multi-stepped technological processes defined on a table of mixes and ingredients

(76) Inventor: Alex Kozachkov, East Brunswick, NJ (US)

Correspondence Address: JEFFREY FURR, 253 N. MAIN STREET, JOHNSTOWN, OH, 43031, US

(21) Appl. No.: 11/161,422

(22) Filed: Aug. 2, 2005

(51) Int. Cl. G05B 13/02

(52) U.S. Cl. 700/28

(57) ABSTRACT

Many technological processes to produce consumer chemicals that do not involve chemical reactions can be defined on a table containing raw materials and mixes along with percentage of each raw material and each previously created mix used to create current mix). The very last mix is the target product. These tables are developed by research groups and get transferred to production. A “calculated product” table tells how much of each ingredient must be used on each step to produce specific amount of the target product. The current invention's approach is to calculate the table from the right to left implicitly using material balance: matter is neither created nor destroyed in industrial non-radioactive processes.

### BACKGROUND

1. Field of the Invention

The present invention relates to a method and system to calculate material requirements for multi-stepped technological processes and, more particularly, as defined on a table of mixes and ingredients.

2. Description of Prior Art

Many technological processes that exist to produce consumer chemicals that do not involve chemical reactions can be defined on a table containing raw materials and mixes along with percentage of each raw material and each previously created mix used to create current mix. These tables are developed by research groups and get transferred to production. However, these tables do not answer the question of how much of each ingredient must be used at each step to produce specific amount of target product. Neither has it given the total amount of each raw material needed to complete the technologic process.

3. Prior Art

U.S. Pat. No. 5,630,070 uses linear programming model for a broader task of optimization of manufacturing resource planning, including resource allocation and production planning. However, it is not apply to technological processes that can be defined on a table containing raw materials and mixes along with percentage of each raw material and each previously created mix used to create current mix. It does not consider a requirement of the raw ingredients that can “disappear” on one or more steps (water gets evaporated).

The need for a better method to calculate material requirements for multi-stepped technological processes shows that there is still room for improvement within the art.

### SUMMARY OF THE INVENTION.

A “calculated product” table tells how much of each ingredient must be used in each step to produce specific amounts of the target product. The current invention's approach is to calculate the table from the right to left implicitly using material balance: matter is neither created nor destroyed in industrial non-radioactive processes.

The process is more efficient, effective, accurate and functional than the current art.

Glossary of Terms Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS.

Without restricting the full scope of this invention, the preferred form of this invention is illustrated in the following drawings:

FIG. 1 is a block diagram showing a basic arrangement of a computer system that embodies the present invention;

FIG. 2 shows an overview of how a User accesses the system;

FIG. 3 shows a table of the ingredients for a mix;

FIG. 4 displays the (n+m) by m table (n-number of raw material, m-number of mixes);

FIG. 5 shows calculating a table at once starting from the last mix and moving backwards;

FIG. 6 displays the target table;

FIG. 7 shows the original formula; and

FIG. 8 shows the calculated product.

### DESCRIPTION OF THE PREFERRED EMBODIMENT

There are a number of significant design features and improvements incorporated within the invention.

Many technological processes to produce consumer chemicals that do not involve chemical reactions can be defined on a table containing raw materials and mixes along with percentage of each raw material and each previously created mix used to create current mix as shown in FIG. 7. The very last mix is the target product. These tables are developed by research groups and get transferred to production.

The table in FIG. 8 is “calculated product”: it tells how much of each ingredient must be used on each step to produce specific amounts of the target product (2000 pounds in this example).

The present invention relates to system 1 and process to calculate the table from the right to left implicitly using material balance where matter is neither created nor destroyed in industrial non-radioactive processes.

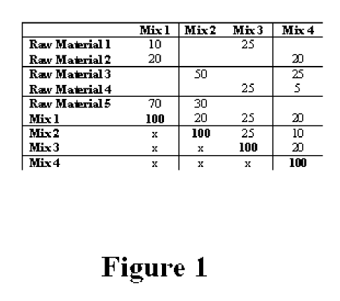

The system 1 is set to run a on a computing device. FIG. 1 is a block diagram showing a computing device 100 on which the present invention can run comprising a processing means such as a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and are not pertinent to the invention. The program is stored on the hard disk drive 120 and run in main memory 150.

The installation of the system 1 on a computing device is very straightforward. There is a Setup program that includes all the files the user would need and uses an installation wizard. After the installation process, the user does not need to restart (reboot) their computer. Installation requires the system's setup execution file.

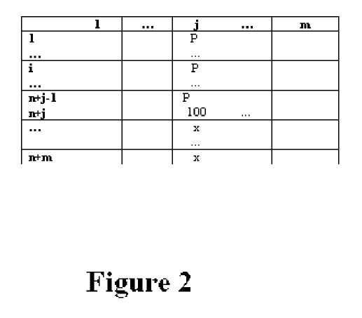

FIG. 2 illustrates a functional diagram of a computer network for World Wide Web 500 access to the System 1 which runs the game 2 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each player 10 will have a display device such as a monitor and input device like a keyboard. This display and input device can even be a PDA like a Blackburn.

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System Web Site 100. In the preferred embodiment the system has numerous web pages. The information in the web pages are in HTML format via the HyperText Transport Protocol (http) and on Server System 310. The System 310 includes software to allow viewing of web pages, commonly referred to as a Web Browser, such as Communicator available from Netscape Communications Corp. or Internet Explorer available from Microsoft Corp. The user system is capable of accessing web pages located on Server System 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 allows for secure input, data transfer and storage of a wide array of information. The system 1 allows and handles the direct transfer of security rights for the Users 10. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows TM version, and the second embodiment can be referred to as a web browser version. The functionality of both embodiments is essentially the same; however, the second embodiment (the web browser version) may incorporate some additional enhancements, as further discussed below. The data processing system in both embodiments utilizes a secure environment to transmit all data through encryption/decryption. The data processing system further provides for an audit trail of modifications made to the recorded data.

The data processing system 1 for both embodiments includes computer processing means for processing data, storage means for storing data on a storage medium, and communication means for transferring data in a secure environment.

For the first embodiment on the Windows TM version, the data is entered on remote work stations and stored in local databases until the user performs a data transmission function which electronically transfers the data to a central database. The central database acts as a central repository enabling multiple off-site users to view and/or modify data, and generate reports or output.

For the second embodiment (the web browser version), it can be conceptually broken down into two main components or groupings that allow the data processing system to achieve its functionality. They are as follows: (1) a main database that acts as the central repository for data entered into the system and (2) a means for processing data or computer software means in the form of coded computer instructions.

For the web browser version, it is unnecessary to have the different installations of the computer software because the web server computer has the entire means for processing loaded thereon. The user in the web browser version logs onto the website and then performs desired functions based upon functions made available to the type of user. Other than consolidation of the means for processing data at the web server computer, and the manner in which data is entered and retrieved through a website, the first and second embodiments have the same functionality, except for those additional features discussed below with respect to the second embodiment.

Many technological processes to produce consumer chemicals that do not involve chemical reactions can be defined on a table containing raw materials and mixes along with percentage of each raw material and each previously created mix used to create current mix.

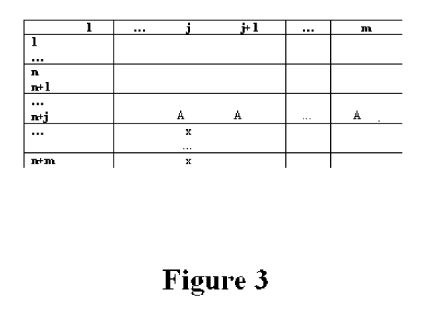

The ingredients, including the mixes, are placed in the table's rows and place the sequence of mixes in the table's columns, as shown in FIG. 3. The very last mix is the target product. Tables similar to the table in FIG. 3 are developed by research groups and get transferred to production. These tables can be entered into an memory means attached to a processing means.

However, these tables did not answer the question of how much of each ingredient must be used on each step to produce specific amount of target product. Neither have they given the total amount of each raw material needed to complete the technological process.

The method below answers these questions by building another table using the original table and the amount of target product as its input. The algorithm is implicitly based on material balance: matter is neither created nor destroyed in industrial non-radioactive processes.

For this invention, T—is amount of the product that is being built.

The system 1 assumes that technological process consists of m-steps (mixes) and requires n-raw materials. It forms (n+m)×m table. The (i,j)—element of the table is Pᵢⱼ —percentage of an ingredient i used in mix j.

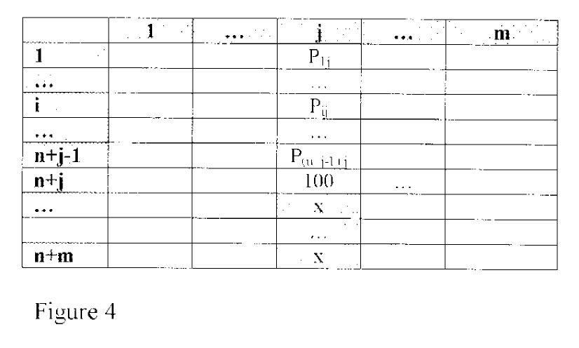

For any column j the following condition is true (see FIG. 4):
^{n+j-1} Σᵢ₌₁Pᵢⱼ₌100 (1)

This represents the fact that total percentages of the ingredients including previously built mixes in the current mix is equal to 100%: P₍ₙ₊ⱼ₎ⱼ=100.

Remaining elements of the column (i=n+j+1 to m+n) are not defined since any mix can be used on subsequent mixes only (not on the previous mixes).

The table being built is Target Table; each Aᵢⱼ element of the table is an amount of an ingredient i used in the mix j.

It is not a good idea to try calculating each Aᵢⱼ individually since any such formula would exponentially depend on the number (n−j) of remaining steps in the technological process.

However, there is a simple fact that lets the system 1 calculate the table at once starting from the last mix and moving backwards.

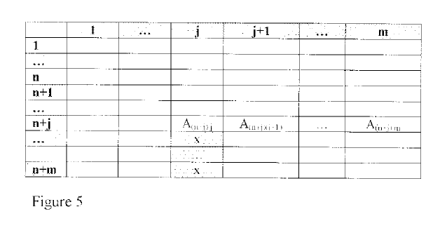

Statement 1 as shown in FIG. 5;
For ∀j>n, A₍ₙ₊ⱼ₎ⱼ=^{m}Σₖ₌ⱼ₊₁A_{(n+j) k.} (2)
To prove this point it is enough to say that the amount of each mix created (A₍ₙ₊ⱼ₎ⱼ) must be equal to the total amounts of this mix used on subsequent steps (material balance).

In the example from FIG. 3, assuming the target amount is 1000, the Target Table is shown on FIG. 6.

Note that each amount in bold is equal to additions of all others numbers from the row, such as 280=30+50+200

The Method Steps of the system 1 and process are as follows:

Step 1. Calculate Last Mix.

Since last mix is the target product, amount of the last mix to build equals to the target amount.

This means that
∀i =1 to m−1 Aᵢₘ=Pᵢₘ/100*T (3)

Step 2. Calculate Next To Last Mix.

Target amount of this mix equal to the amount of this mix used in the very last mix
(A_{(n+m-1) m}).
Since it is previously calculated, the system 1 can use a formula similar to (3)
∀i=1 to m−2 A_{i (m-1)}=P_{i m}/100*A₍ₙ₊ₘ₋₁₎ₘ (4)

Step j

Using Statement 1 to Find the Amount of Mix j

Calculate each ingredient in this mix by using the following formula:
∀i=1 to m−2 A_{i (m-1)}=Pᵢₘ/100*A₍ₙ₊ₘ₋₁₎ₘ (5)

Basically, calculation of current mix is done by finding target amount of the mix in subsequent columns.

It should be noted that using negative amounts does not affect this algorithm since we never assumed that Aᵢⱼ is a positive number in the first place. This represents the fact that some of the raw materials can be various types of water and we can loose water in any technological step.

Implementaion

The method that is implemented can be a Web based or a desktop based system 1. The system 1 in the preferred embodiment would have the following functionalities available:

The Formula Builder: an interface for building and saving new Formulas

An interface to the database of Formulas that allows users to open, calculate and delete Formulas.

An algorithm that is programmed into the digital memory of the system to calculate material requirements with requested precision.

Means to support the databases stored in digital memory of the system 1 of Raw Materials and Types Of Waters used to build Formulas.

Page level access control based on user's roles obtained during authentication with the system.

The following technologies were used to implement the system 1 in the preferred embodiment:

User interface: JSP (Java Server Pages) with client-side JavaScript validation

Calculations: Java Servlets

Database: any JDBC-Enabled (Java Database Connectivity) Server Database can be used. This system is running on MySQL, the most popular Open Source Database

Application Server: any Application Server supporting Java Servlets and JSPs can be used. This system is running on Tomcat, the servlet container that is used in the official Reference Implementation for the Java Servlet and JSPs technologies.

Many technological processes to produce consumer chemicals that do not involve chemical reactions can be defined on a table containing raw materials and mixes along with percentage of each raw material and each previously created mix used to create current mix. The very last mix is the target product. These tables are developed by research groups and get transferred to production.

FIG. 8 is the “calculated product”: it tells how much of each ingredient must be used in each step to produce a specific amount of the target product (2000 pounds in our example).

This approach is to calculate the table from the right to left implictly using material balance: matter is neither created nor destroyed in industrial non-radioactive processes.

The systems 1 output can include a webpage, a graphical user interface, hardcopy, facsimile, e-mail, messaging or other communication with any humanly or machine discernable data and/or artifacts.

Conclusion

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for optimizing component allocation of a plurality of components to product a product, comprising steps of:
having a table where a plurality of ingredients are placed in said table's rows and a sequence of mixes in said table's columns, having the last column in said table being said product, using said table to build another table using said table and amount of said product to be produced as inputs.

2. A method according to claim 1, wherein having said table loaded onto a memory means.

3. A method according to claim 1, wherein having said table loaded through the use of a website.

4. A method according to claim 1, wherein the processing of said table consists of m-steps (mixes) and requires n-raw materials forming a (n+m)×m table with the (i,j)—element of the table is Pᵢⱼ—percentage of an ingredient i used in mix j.

5. A method according to claim 1, further comprising having the amount of each mix created (A_{n+j,j}) must be equal to the total amounts of this mix used on subsequent steps.

6. A method according to claim 1, further comprising having the steps of calculating the last mix and calculating the next to last mix.

7. A method according to claim 1, wherein having an n interface to a database of formulas that allow a user to open, calculate and delete formulas.

8. A method according to claim 1, further comprising having means to support the databases stored in digital memory of the system of raw materials and types Of waters used to build Formulas.

9. A method according to claim 1, further comprising having an interface for building and saving new Formulas.

10. A method according to claim 1, further comprising having the calculated results written to an output means.

11. A computer processing system for optimizing component allocation of a plurality of components to product a product, comprising:
having a table stored in a memory means where a plurality of ingredients are placed in said table's rows and a sequence of mixes in said table's columns, having the last column in said table being said product, using a processing means and said table to build another table stored in a memory means using said table and amount of said product to be produced as inputs.

12. A computer processing system according to claim 11, wherein having said table loaded onto a memory means.

13. A computer processing system according to claim 11, wherein having said table loaded through the use of a website.

14. A computer processing system according to claim 11, wherein the processing of said table consists of m-steps (mixes) and requires n-raw materials forming a (n+m) X m table with the (i,j)—element of the table is Pᵢⱼ—percentage of an ingredient i used in mix j.

15. A computer processing system according to claim 11, further comprising having the amount of each mix created (A_{n+j,j}) must be equal to the total amounts of this mix used on subsequent steps.

16. A computer processing system according to claim 11, further comprising having the steps of calculating the last mix and calculating the next to last mix.

17. A computer processing system according to claim 11, wherein having an n interface to a database of formulas that allow a user to open, calculate and delete formulas.

18. A computer processing system according to claim 11, further comprising having means to support the databases stored in digital memory of the system of raw materials and types Of waters used to build Formulas.

19. A computer processing system according to claim 11, further comprising having an interface for building and saving new Formulas.

20. A computer processing system according to claim 11, further comprising having the calculated results written to an output means.
